(19) United States
(12) Patent Application Publication
(10) Pub. No.: US 2012/0038573 A1
(43) Pub. Date: Feb. 16, 2012

(54) Touch Input Device and Scanning Method Thereof

(75) Inventors: Yu Kuang, Hsinchu City (TW); Shih Tzung Chou, Zhudong Township (TW); Ya Ling Lu, Pingtung City (TW); Hsu Ming Chuang, Taichung City (TW)

(73) Assignee: Raydium Semiconductor Corporation, Hsinchu (TW)

(21) Appl. No.: 13/207,047

(22) Filed: Aug. 10, 2011

(30) Foreign Application Priority Data
Aug. 13, 2010 (TW) 099127043

(51) Int. Cl. G06F 3/041

(52) U.S. Cl. 345/173

(57) ABSTRACT

A touch panel includes a plurality of X-directional sensing lines and a plurality of Y-directional sensing lines. The X-directional sensing lines and the Y-directional sensing lines are arranged in a staggered manner, and a plurality of mutual capacitors are formed between every X-directional sensing line and every Y-directional sensing line. According to one embodiment of the present invention, the scanning method first selects the number of sensing lines to be measured to determine a measurement channel. Driving signals are applied to other sensing lines excluding the measurement channel in scanning procedures. After the driving signals are applied, two voltages at nodes of the measurement channel are detected to obtain a touch position on the touch panel.

### BACKGROUND OF THE INVENTION

1. Field of the Invention

The present invention relates to a scanning method for a touch panel.

2. Description of the Related Art

Touch panels are widely applied in a variety of fields such as home appliances, communication devices and electronic information devices. The touch panel is often applied in input interfaces of personal digital assistants (PDAs), electronic products and game consoles. The current trend of integrating a touch panel and a display allows a user to select an icon displayed on the panel by using a finger or a touch pen, so that the PDA, the electric product, or the game console executes a desired function. The touch panel may also be applied in a public information inquiry system, so that the user can operate the system more efficiently.

In order to effectively detect a correct position at which the user touches the panel, multiple technologies of the touch panel have been developed. For example, the touch panel may be designed as a capacitive touch panel, which is based on the positioning principle of judging a touch position according to a change of capacitance of a sensing grid embedded in the touch panel. In addition to the capacitive touch panel, other touch panels based on different sensing principles include resistive touch panels, optical touch panels and surface acoustic wave touch panels.

FIG. 1 is a schematic view of a conventional touch panel 10. The touch panel 10 includes a plurality of X-directional sensing lines X1 to Xm, and a plurality of Y-directional sensing lines Y1 to Yn, where m and n are the same or different positive integers. The X-directional sensing lines X1 to Xm and the Y-directional sensing lines Y1 to Yn are embedded in different layers of the touch panel 10. Referring to FIG. 1, the X-directional sensing lines X1 to Xm and the Y-directional sensing lines Y1 to Yn are arranged in a staggered manner, thereby forming a sensing grid. In the sensing grid, a plurality of mutual capacitors (not shown) are formed between every X-directional sensing line and every Y-directional sensing line.

FIG. 2 is a schematic view of a conventional touch input device 20. The touch input device 20 includes the precedent touch panel 10, an X-directional driving channel selection module 22, a Y-directional driving channel selection module 24 and a touch sensing circuit 26. Referring to FIG. 2, the touch sensing circuit 26 includes a selection module 262 and a differential detection module 264. The selection module 262 further includes a first multiplex selector 2622, a second multiplex selector 2624 and a control circuit 2626 for controlling the above multiplex selectors.

During operation, the first multiplex selector 2622 selects one or more sensing lines from the X-directional sensing lines X1 to Xm, or selects one or more sensing lines from the Y-directional sensing lines Y1 to Yn, so as to select a first induced voltage. Meanwhile, the second multiplex selector 2624 selects one or more sensing lines that are not selected by the first multiplex selector 2622 from the X-directional sensing lines X1 to Xm, or selects one or more sensing lines that are not selected by the first multiplex selector 2622 from the Y-directional sensing lines Y1 to Yn, so as to select a second induced voltage. The first and second induced voltages are generated respectively by a mutual capacitor inducing an excitation signal. The first and second induced voltages are input into the differential detection module 264. The values of the induced voltages change as a user touches the mutual capacitors, so that a touch position of the user can be acquired by detecting differences between the induced voltages.

The touch panel 10 in FIG. 1 detects a position touched by a user by scanning the sensing lines in a sequential manner. However, in a conventional scanning manner, initial values of the first and second induced voltages change according to a state of corresponding sensing lines in a previous scanning sequence, thereby causing steady-state values of the first and second induced voltages to drift.

Therefore, it is necessary to provide a scanning method for a touch panel to solve the above problems.

### SUMMARY OF THE INVENTION

The present invention discloses a scanning method for a touch panel. The touch panel includes a plurality of X-directional sensing lines and a plurality of Y-directional sensing lines. The X-directional sensing lines and the Y-directional sensing lines are arranged in a staggered manner, and a plurality of mutual capacitors are formed between every X-directional sensing line and every Y-directional sensing lines. The method includes selecting the number of sensing lines to be measured; selecting a plurality of first sensing lines from the X-directional sensing lines as a measurement channel according to the number of sensing lines; outputting a driving signal to other sensing lines excluding the first sensing lines during a first scan; detecting two first voltages on the measurement channel during the first scan; outputting the driving signal to the first sensing lines during a second scan; and detecting two second voltages on the shifted measurement channel according to the number of sensing lines to be measured during the second scan.

The present invention discloses another scanning method for a touch panel. The touch panel includes a plurality of X-directional sensing lines and a plurality of Y-directional sensing lines. The X-directional sensing lines and the Y-directional sensing lines are arranged in a staggered manner, and a plurality of mutual capacitors are formed between every X-directional sensing line and every Y-directional sensing line. The method includes the following steps: selecting the number of sensing lines to be measured; selecting a number of first sensing lines from the X-directional sensing lines as a measurement channel according to the number of sensing lines; outputting a driving signal to the Y-directional sensing lines and floating other sensing lines of the X-directional sensing lines during a first scan; detecting two first voltages on the measurement channel during the first scan; floating the first sensing lines during a second scan; and detecting two second voltages on the shifted measurement channel according to the number of sensing lines to be measured during the second scan.

The present invention discloses a touch input device. The touch input device includes a touch panel and a panel driving circuit configured to drive the touch panel. The touch panel includes a plurality of X-directional sensing lines and a plurality of Y-directional sensing lines. The X-directional sensing lines and the Y-directional sensing lines are arranged in a staggered manner, and a plurality of mutual capacitors are formed between every X-directional sensing line and every Y-directional sensing line. The panel driving circuit includes a selection circuit, a driving signal generation circuit, and a detection circuit. The selection circuit is configured to select and shift a measurement channel according to the number of sensing lines to be measured. The driving signal generation circuit is configured to output a driving signal to other sensing lines excluding the measurement channel according to an output signal of the selection circuit. The detection circuit is configured to detect two voltages on the measurement channel.

### BRIEF DESCRIPTION OF THE DRAWINGS

The invention will be described according to the appended drawings in which:

FIG. 1 is a schematic view of a conventional touch panel;

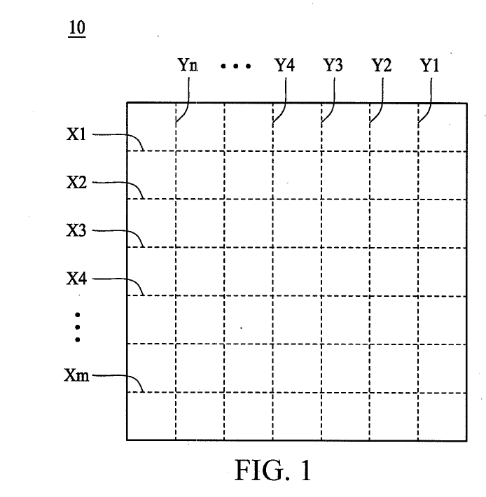

FIG. 2 is a schematic view of a conventional touch input device;

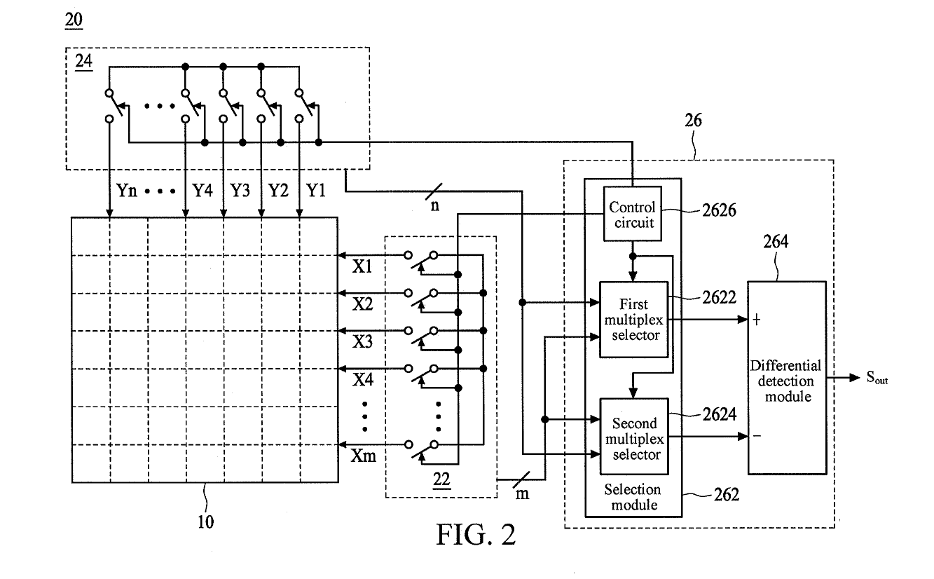

FIG. 3 is a schematic block diagram of a touch input device according to an embodiment of the present invention;

FIG. 4 is a flow chart of a scanning method according to an embodiment of the present invention;

FIG. 5 is an example implemented according to the scanning method in FIG. 4;

FIG. 6 is a flow chart of a scanning method according to another embodiment of the present invention;

FIG. 7 is an example implemented according to the scanning method in FIG. 6;

FIG. 8 is another example implemented according to the scanning method in FIG. 4;

FIG. 9 is another example implemented according to the scanning method in FIG. 6;

FIG. 10 is another example implemented according to the scanning method in FIG. 4; and

FIG. 11 is yet another example implemented according to the scanning method in FIG. 4.

### DETAILED DESCRIPTION OF THE INVENTION

The present invention is directed to a touch panel and a scanning method thereof. In order to make the present invention completely comprehensible, detailed steps and structures are provided in the following description. Obviously, implementation of the present invention does not limit special details known by persons skilled in the art. In addition, known structures and steps are not described in details, so as not to limit the present invention unnecessarily. Preferred embodiments of the present invention will be described below in detail. However, in addition to the detailed description, the present invention may also be widely implemented in other embodiments. The scope of the present invention is not limited to the detailed description, and is defined by the claims.

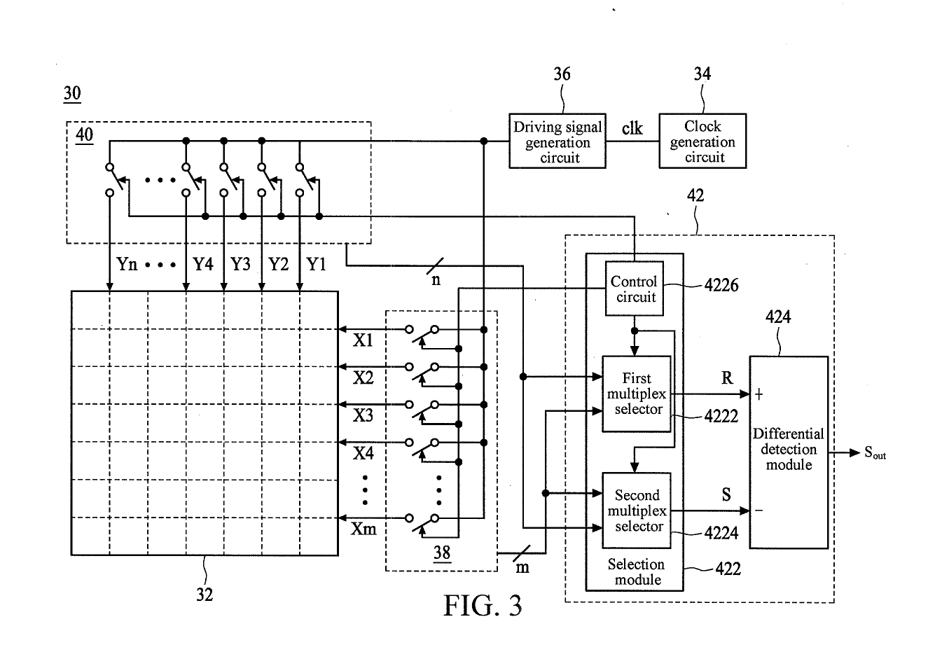

In order to illustrate a scanning method of the present invention more smoothly, a touch input device executing the method of the present invention is first described below. FIG. 3 is a schematic block diagram of a touch input device 30 according to an embodiment of the present invention. The touch input device 30 includes a touch panel 32, a clock generation circuit 34, a driving signal generation circuit 36, an X-directional sensing line selection module 38, a Y-directional sensing line selection module 40 and a touch sensing circuit 42. Referring to FIG. 3, the touch sensing circuit 42 includes a selection module 422 and a differential detection module 424. The selection module 422 further includes a first multiplex selector 4222, a second multiplex selector 4224, and a control circuit 4226 for controlling the multiplex selectors.

In this embodiment, the touch panel 32 includes a plurality of X-directional sensing lines X1 to X10 and a plurality of Y-directional sensing lines Y1 to Y10. The X-directional sensing lines X1 to X10 and the Y-directional sensing lines Y1 to Y10 are embedded in different layers of the touch panel 32. Referring to FIG. 3, the X-directional sensing lines X1 to Xm and the Y-directional sensing lines Y1 to Yn are arranged in a staggered manner, thereby forming, but not limited to forming, a check-shaped grid. In the check-shaped grid, a plurality of mutual capacitors (not shown) are formed between the X-directional sensing lines and the Y-directional sensing lines.

The clock generation circuit 34 generates a clock signal clk to the driving signal generation circuit 36. The driving signal generation circuit 36 generates a driving signal DP to the X-directional sensing lines X1 to X10 and the Y-directional sensing lines Y1 to Y10 according to the clock signal clk. The driving signal DP may be, but is not limited to, a square wave driving signal, a triangular wave driving signal or a sine wave driving signal.

The first multiplex selector 4222 is configured to select one or more sensing lines from the X-directional sensing lines X1 to X10, or to select one or more sensing lines from the Y-directional sensing lines Y1 to Y10, so as to select a first induced voltage. The second multiplex selector 4224 is configured to select one or more sensing lines that are not selected by the first multiplex selector 4222 from the X-directional sensing lines X1 to X10, or to select one or more sensing lines that are not selected by the first multiplex selector 4222 from the Y-directional sensing lines to select a second induced voltage. The first and second induced voltages are input into the differential detection module 424. When an intersection of the X-directional sensing lines X1 to X10 and the Y-directional sensing lines Y1 to Y10 is touched, a mutual capacitance value changes, so that values of the induced voltages change. According to an output result of the differential detection module 424, a position touched by a user is acquired.

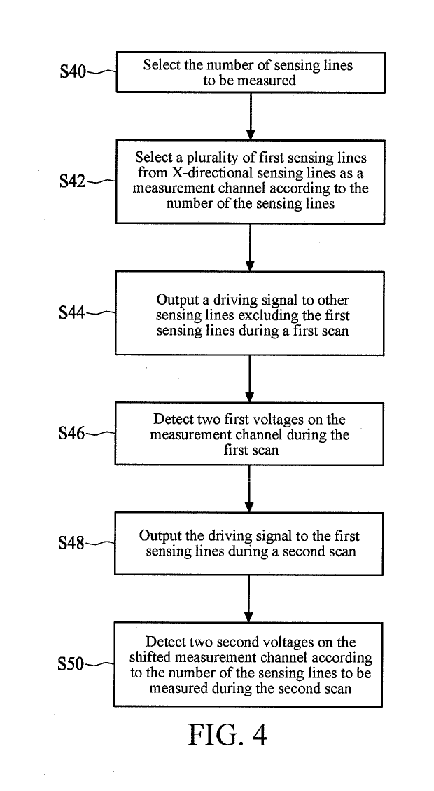

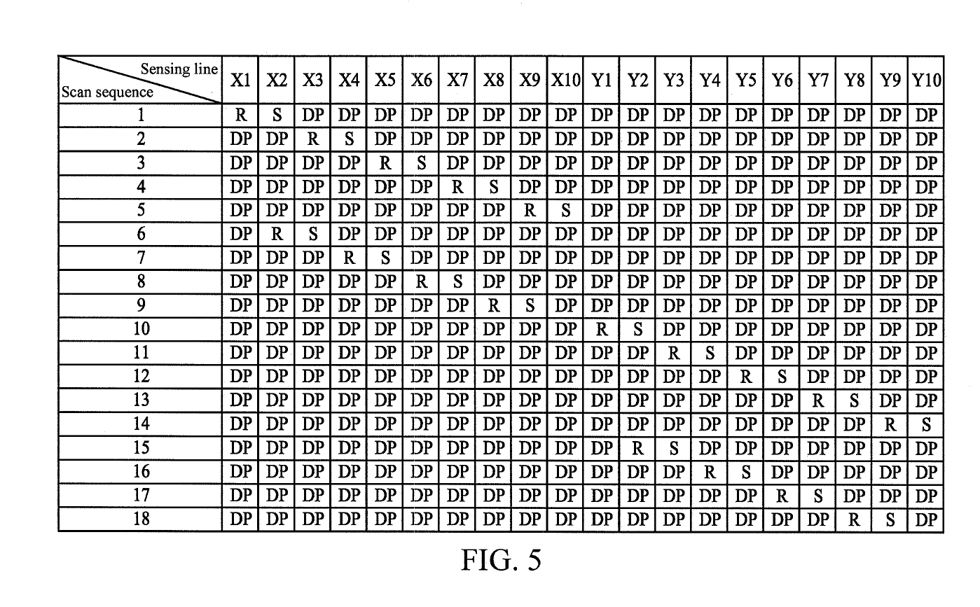

FIG. 4 is a flow chart of a scanning method according to an embodiment of the present invention, and the scanning method is applied in the touch input device. The method includes the following steps: selecting the number of sensing lines to be measured (Step S40); selecting a plurality of first sensing lines from X-directional sensing lines as a measurement channel according to the number of the sensing lines (Step S42); outputting a driving signal to other sensing lines excluding the in sensing lines during a first scan (Step S44); detecting two first voltages on the measurement channel during the first scan (Step S46); outputting the driving signal to the first sensing lines during a second scan (Step S48); and detecting two second voltages on the shifted measurement channel according to the number of sensing lines to be measured during the second scan (Step S50). Details of the scanning method of the present invention are described below with reference to the device in FIG. 3 and a scanning sequence in FIG. 5.

In Step S40, the number of sensing lines to be measured is selected. The number of sensing lines is an integer larger than or equal to 2. FIG. 5 is an example implemented according to the scanning method in FIG. 4. In the example, the number of sensing lines to be measured is set to be 2, and the sensing lines X1 and X2 of the X-directional sensing lines are set as an initial measurement channel. Referring to FIG. 5, during the first scan, a driving signal DP is output to other sensing lines excluding the sensing lines X1 and X2. During the first scan, a voltage on the sensing line X1 may be selected by the first multiplex selector 4222 to be transmitted to a first input end R of the differential detection module 424. Meanwhile, a voltage on the sensing line X2 may be selected by the second multiplex selector 4224 to be transmitted to a second input end S of the differential detection module 424. The differential detection module 424 may detect a to difference between the two voltage values selected by the first and second multiplex selectors 4222 and 4224 to generate a touch sensing signal Sₒᵤₜ.

Next, during the second scan, the initial measurement channel shifts to the right to form a new measurement channel, that is, the sensing lines X3 and X4. Therefore, the driving signal generation circuit 36 outputs the driving signal DP to other sensing lines excluding the sensing lines X3 and X4. During the second scan, a voltage on the sensing line X3 may be selected by the first multiplex selector 4222 to be transmitted to the first input end R of the differential detection module 424. Meanwhile, a voltage on the sensing line X4 may be selected by the second multiplex selector 4224 to be transmitted to the second input end S of the differential detection module 424. The differential detection module 424 generates the touch sensing signal Sₒᵤₜ according to the voltage values at the two input ends.

Similarly, in other scanning sequences, the measurement channel shifts to the right in sequence. The driving signal DP is input into the sensing lines excluding the measurement channel. Under a coupling effect of the mutual capacitor, the driving signal DP is coupled to nodes of the measurement channel. If a user touches the nodes, a capacitance value of the mutual capacitor changes, thereby causing the voltage to change. By detecting the change of the voltages, a touched position on the touch panel 32 can be acquired. In the present embodiment, a previous state of the measurement channel set each time is always a driven state. Therefore, during each scan, initial voltage values of the nodes of the measurement channel are the same, and a steady-state voltage value thereof can truly reflect a change of the capacitance value of the mutual capacitor.

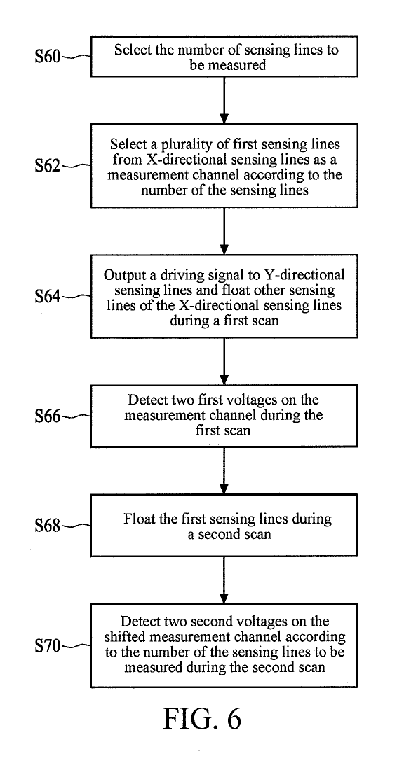

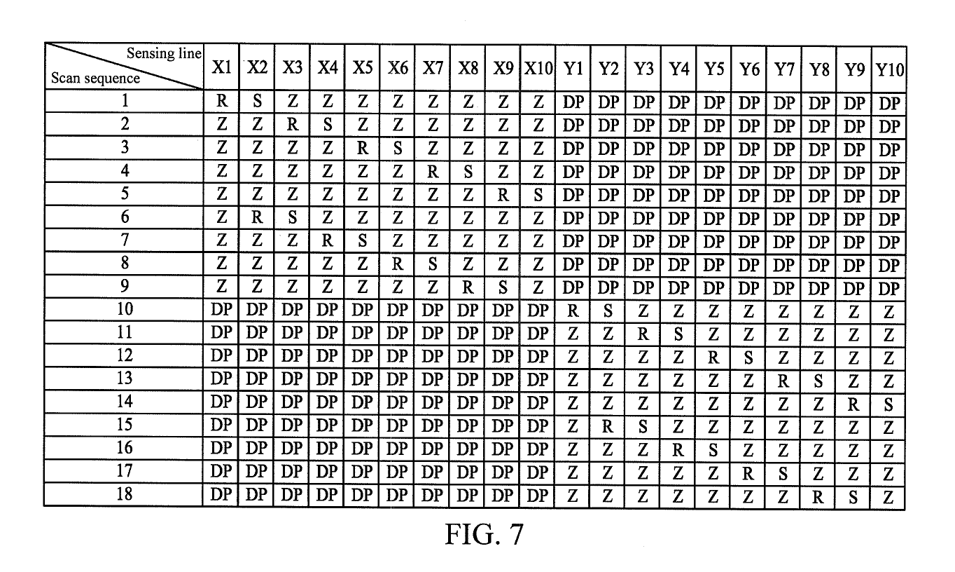

FIG. 6 is a flow chart of a scanning method according to another embodiment of the present invention, and the scanning method is applied in the touch input device. The method includes the following steps: selecting the number of sensing lines to be measured (Step S60); selecting a number of first sensing lines from X-directional sensing lines as a measurement channel according to the number of the sensing lines (Step S62); outputting a driving signal to the Y-directional sensing lines and floating other sensing lines of the X-directional sensing lines during a first scan (Step S64); detecting two first voltages on the measurement channel during the first scan (Step S66); floating the first sensing lines during a second scan (Step S68); and detecting two second voltages on the shifted measurement channel according to the number of sensing lines to be measured during the second scan (Step S70). The term ‘floating’ refers to the lack of voltage applied to a sensing line. That is, the sensing lines are in a high impedance state. Details of the scanning method of the present invention are described below with reference to the device in FIG. 3 and a scanning sequence in FIG. 7.

In Step S60, the number of sensing lines to be measured is first selected. The number of sensing lines is an integer larger than or equal to 2. FIG. 7 shows an example implemented according to the scanning method in FIG. 6. In the example, the number of sensing lines to be measured is set to 2, and the sensing lines X1 and X2 of the X-directional sensing lines are set as an initial measurement channel. Referring to FIG. 7, during the first scan, a driving signal DP is output to the Y-directional sensing lines Y1 to Y10, and other sensing lines of the X-directional sensing lines are floated. During the first scan, a voltage on the sensing line X1 may be selected by the first multiplex selector 4222 to be transmitted to the first input end R of the differential detection module 424. Meanwhile, a voltage on the sensing line X2 may be selected by the second multiplex selector 4224 to be transmitted to the second input end S of the differential detection module 424. The differential detection module 424 may detect a difference between the two voltage values selected by the first and second multiplex selectors 4222 and 4224 to generate a touch sensing signal Sₒᵤₜ.

During the second scan, the initial measurement channel shifts to the right to form a new measurement channel, that is, the sensing lines X3 and X4. Therefore, the driving signal generation circuit 36 outputs the driving signal DP to the Y-directional sensing lines Y1 to Y10, and the sensing lines excluding the sensing lines X3 and X4 are in a floated state. During the second scan, a voltage on the sensing line X3 may be selected by the first multiplex selector 4222 to be transmitted to the first input end R of the differential detection module 424. Meanwhile, a voltage on the sensing line X4 may be selected by the second multiplex selector 4224 to be transmitted to the second input end S of the differential detection module 424. The differential detection module 424 generates the touch sensing signal Sₒᵤₜ according to the voltage values at the two input ends.

Similarly, in other scanning sequences the measurement channel shifts to the right in sequence. The driving signal DP is input into the sensing lines excluding the measurement channel, or the sensing lines excluding the measurement channel are kept in a floated state. Under a coupling effect of the mutual capacitor, the driving signal is coupled to nodes of the measurement channel. If a user touches the nodes, a capacitance value of the mutual capacitor changes, thereby causing the voltage to change. By detecting the change of the voltages, a touched position on the touch panel 32 can be acquired. In the present embodiment, a previous state of the measurement channel set each time is always a floated state. Therefore, during each scan, initial voltage values of the nodes of the measurement channel are the same, and a steady-state voltage value thereof can truly reflect a change of the capacitance value of the mutual capacitor.

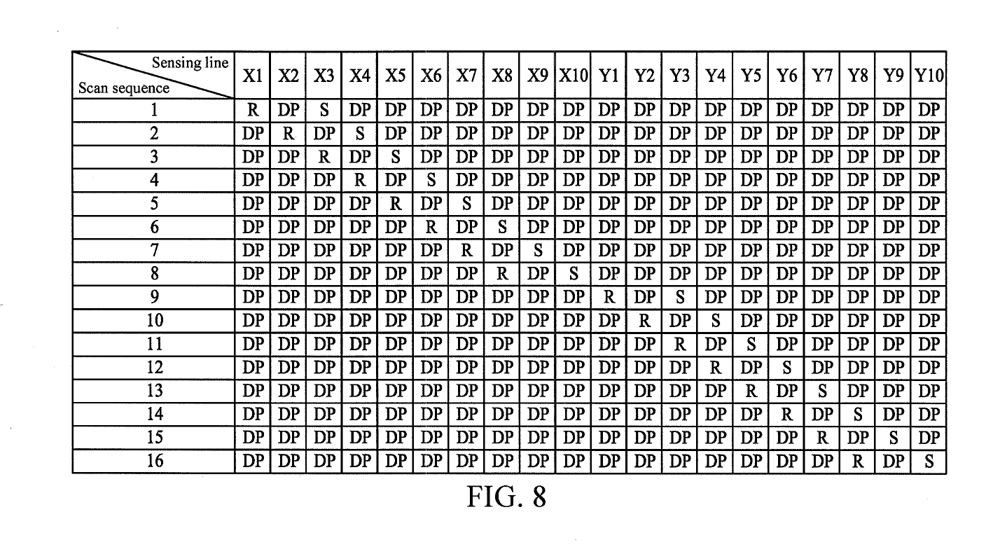

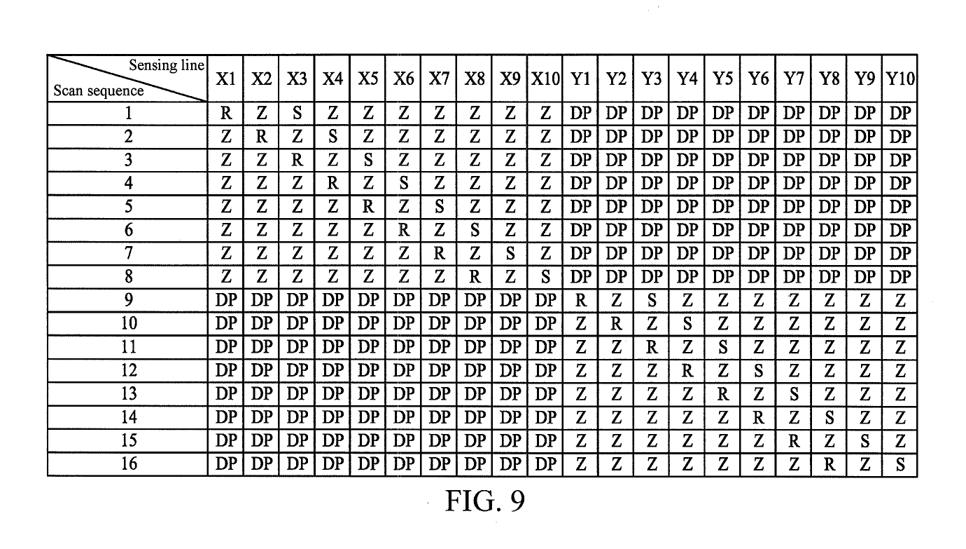

Referring to FIG. 5 and FIG. 7, a plurality of sensing lines of an initial measurement channel are set to be adjacent to each other. However, according to another embodiment of the present invention, a plurality of sensing lines of an initial measurement channel may be set to be arranged alternately, as shown in FIG. 8 and FIG. 9. Referring to FIG. 8, the sensing line X2 is between the sensing lines X1 and X3, and sensing lines X1 and X3 are set as initial measurement channels. When the driving panel performs the first scan, the sensing lines X2 and X4 are in the driven state. When the driving panel performs the second scan, the sensing lines X2 and X4 are set as the measurement channel. Due to the previous states of the measurement channels are the same (both in the driven state), an initial voltage values on the measurement channels are the same, and a steady-state voltage value thereof can truly reflect a change of the capacitance value of the mutual capacitor. Similarly, when the driving panel in FIG. 9 performs the first scan, the sensing lines X2 and X4 are in the floated state. When the second scan is performed, the sensing lines X2 and X4 are set as the measurement channels. Due to the previous states of the measurement channels are the same (both in the floated state), the initial voltage values on the measurement channels are the same.

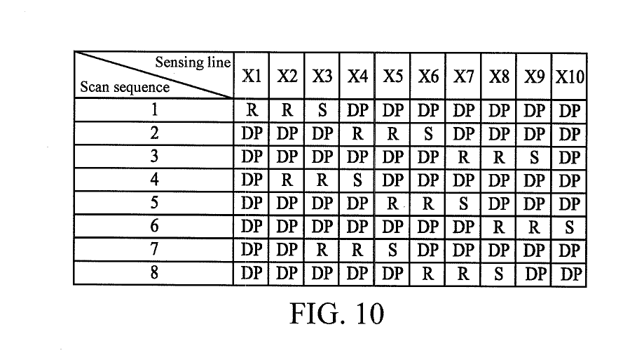

FIG. 10 is another example implemented according to the scanning method in FIG. 4. In the example, the number of sensing lines to be measured is set to 3, and the sensing lines X1, X2 and X3 of the X-directional sensing lines are set as initial measurement channels. When the driving panel in FIG. 10 performs the first scan, the sensing lines X4, X5 and X6 are in the driven state. Next, when the second scan is performed, the sensing lines X4, X5 and X6 are set as the measurement channels. The previous states of the measurement channels are the same (all in the driven state), the initial voltage values on the measurement channels are the same.

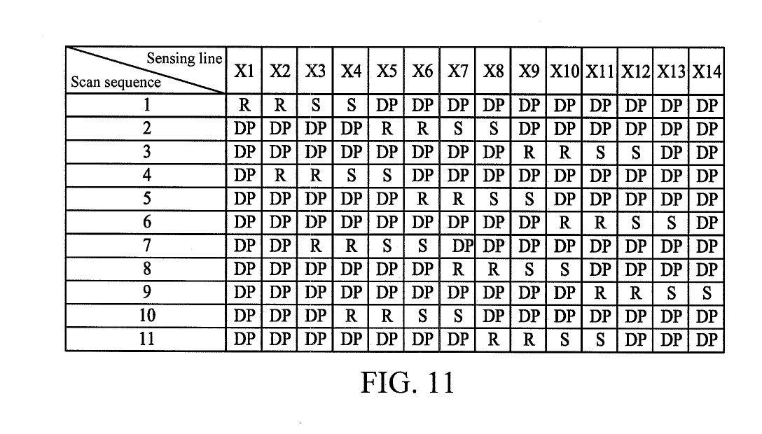

FIG. 11 is yet another example implemented according to the scanning method in FIG. 4. In the example, the number of sensing lines to be measured is set to 4, and the sensing lines X1, X2, X3 and X4 of the X-directional sensing lines are set as an initial measurement channel. When the driving panel in FIG. 11 performs the first scan, the sensing lines X5, X6, X7 and X8 are in the driven state. When the second scan is performed, the sensing lines X5, X6, X7 and X8 are set as the measurement channels. The previous states of the measurement channels are the same (all in the driven state), so that the initial voltage values on the measurement channels are the same. According to another embodiment of the present invention, when the driving panel in FIG. 11 performs the first scan, the sensing lines X5, X6, X7 and X8 may be in the floated state.

In the touch panel implemented according to the scanning method of the present invention, the minimum number of X-directional sensing lines or the minimum number of Y-directional sensing lines may depend on the number of sensing lines to be measured. In a preferred embodiment, the minimum number of X-directional sensing lines or the minimum number of Y-directional sensing lines is determined according to the following equation (1):

Num=4×N_{SET}−2 (1)

where Num represents the minimum number of X-directional sensing lines or the minimum number of Y-directional sensing lines, and N_{SET} represents the set number of the initial measurement channel. For example, as shown in FIG. 10, when the number of the sensing lines to be measured is set to 3, in order to completely detect all nodes of the X-directional sensing lines or the Y-directional sensing lines of the touch panel, the minimum number of X-directional sensing lines or the minimum number of Y-directional sensing lines of the touch panel has to be 4×3−2=10. In another embodiment, as shown in FIG. 11, when the number of sensing lines to be measured is set to be 4, in order to completely detect all nodes of the X-directional sensing lines or the Y-directional sensing lines of the touch panel, the minimum number of X-directional sensing lines or the minimum number of Y-directional sensing lines of the touch panel has to be 4×4−2=14.

Although the technical contents and features of the present invention are described above, various replacements and modifications can be made by persons skilled in the art based on the teachings and invention of the present invention without departing from the spirit thereof. Therefore, the scope of the present invention is not limited to the described embodiments, but covers various replacements and modifications that do not depart from the present invention as defined by the appended claims.

What is claimed is:

1. A scanning method applied in a touch panel, wherein the touch panel comprises a plurality of X-directional sensing lines and a plurality of Y-directional sensing lines, the X-directional sensing lines and the Y-directional sensing lines are arranged in a staggered manner, and a plurality of mutual capacitors are formed between each X-directional sensing line and each Y-directional sensing line, the method comprising the steps of:
selecting a number of sensing lines to be measured;
selecting a plurality of first sensing lines from the X-directional sensing lines as a measurement channel according to the number of sensing lines;
outputting a driving signal to other sensing lines excluding the first sensing lines during a first scan;
detecting two first voltages on the measurement channel during the first scan;
outputting the driving signal to the first sensing lines during a second scan; and
detecting two second voltages on a shifted measurement channel according to the number of sensing lines to be measured during the second scan to sense a touch position.

2. The scanning method according to claim 1, wherein the plurality of sensing lines set as the measurement channel are arranged adjacent to each other.

3. The scanning method according to claim 1, wherein the plurality of sensing lines set as the measurement channel are arranged alternately.

4. The scanning method according to claim 1, further comprising a step of determining a touch position of a user according to the first and the second voltages.

5. The scanning method according to claim 1, wherein a minimum number of X-directional sensing lines or a minimum number of Y-directional sensing lines of the touch panel is determined by the following equation:
Num=4×N_{SET}−2;
wherein Num represents the minimum number of X-directional sensing lines or the minimum number of Y-directional sensing lines, and N_{SET} represents the number of sensing lines to be measured.

6. A scanning method applied in a touch panel, wherein the touch panel comprises a plurality of X-directional sensing lines and a plurality of Y-directional sensing lines, the X-directional sensing lines and the Y-directional sensing lines are arranged in a staggered manner, and a plurality of mutual capacitors are formed between each X-directional sensing line and each Y-directional sensing line, the method comprising the steps of:
selecting the number of sensing lines to be measured;
selecting a plurality of first sensing lines from the X-directional sensing lines as a measurement channel according to the number of the sensing lines;
during a first scan, outputting a driving signal to the Y-directional sensing lines, and floating other sensing lines of the X-directional sensing lines;
detecting two first voltages on the measurement channel during the first scan;
floating the first sensing lines during a second scan; and
detecting two second voltages on a shifted measurement channel according to the number of sensing lines to be measured during the second scan to sense a touch position.

7. The scanning method according to claim 6, wherein the plurality of sensing lines set as the measurement channel are arranged adjacent to each other.

8. The scanning method according to claim 6, wherein the plurality of sensing lines set as the measurement channel are arranged alternately.

9. The scanning method according to claim 6, further comprising a step of determining a touch position of a user according to the first and the second voltages.

10. The scanning method according to claim 6, wherein a minimum number of X-directional sensing lines or a minimum number of Y-directional sensing lines of the touch panel is determined by the following equation:
Num=4×N_{SET}−2;
wherein Num represents the minimum number of X-directional sensing lines or the minimum number of Y-directional sensing lines, and N_{SET} represents the number of sensing lines to be measured.

11. A touch input device, comprising:
a touch panel, comprising:
a plurality of X-directional sensing lines;
a plurality of Y-directional sensing lines, wherein the X-directional sensing lines and the Y-directional sensing lines are arranged in a staggered manner; and
a plurality of mutual capacitors, formed between each X-directional sensing line and each Y-directional sensing line; and
a panel driving circuit, configured to drive the touch panel, wherein the panel driving circuit comprises:
a selection circuit, configured to select and shift a measurement channel according to the number of sensing lines to be measured;
a driving signal generation circuit, configured to output a driving signal to other sensing lines excluding the measurement channel according to an output signal of the selection circuit; and
a detection circuit, configured to detect two voltages on the measurement channel.

12. The touch input device according to claim 11, wherein the plurality of sensing lines in the measurement channel are arranged adjacent to each other.

13. The touch input device according to claim 11, wherein the plurality of sensing lines in the measurement channel are arranged alternately.

14. The touch input device according to claim 11, further comprising a judgment circuit, configured to judge a touch position of a user according to the two voltages detected by the detection circuit.
